(19) United States
(12) Patent Application Publication
(10) Pub. No.: US 2015/0153891 A1
(43) Pub. Date: Jun. 4, 2015

(54) ELECTRONIC DEVICE AND METHOD FOR INITIALIZINIG TOUCH SCREEN THEREOF

(71) Applicant: Chiun Mai Communication Systems, Inc., New Taipei (TW)

(72) Inventor: KUO-WEI LEE, New Taipei (TW)

(21) Appl. No.: 14/470,634

(22) Filed: Aug. 27, 2014

(30) Foreign Application Priority Data
Nov. 30, 2013 (CN) 2013106222824

(51) Int. Cl. G06F 3/041

(52) U.S. Cl. CPC G06F 3/0416

(57) ABSTRACT

A method for maintaining a touch screen in a state constantly ready for user touches is applied to an electronic device with a touch screen. The touch screen includes a number of electrodes. The electronic device includes a sensor to periodically detect readings of the electronic device in terms of immobility as against physical movement or in terms of ambient circumstances. The method obtains readings from the detecting sensor when the touch screen is woken up and determining any difference between the instant reading and previous readings taken as parameters. The variance between the instant reading and the established parameter is determined and the electrical potentials of the electrodes are adjusted to be the same if the variance is greater than the preset value.

### FIELD

The present disclosure relates to electronic devices, and particularly to an electronic device having a touch screen and a method for initializing the touch screen.

### BACKGROUND

Many electronic devices, such as mobile phones, tablet computers, and multimedia players, employ touch screens as input interfaces. Such a touch screen usually includes a number of electrodes arranged in X direction and Y direction. Before a user operation is performed on the touch screen, the electrodes have a uniform electrical potential, that is to say, there is almost no potential differences between the electrodes.

The touch screen may fail to respond to the user's operations if the electrodes have different electrical potentials. To overcome this problem, the user needs to press the power button to turn off the touch screen, and further press the power button again to wake up the touch screen, to cause the electronic device to adjust the electrical potentials of the electrodes to the same level, namely, to initialize the touch screen.

### BRIEF DESCRIPTION OF THE DRAWINGS

Many aspects of the present disclosure can be better understood with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of an embodiment of an electronic device.

FIG. 2 is a flowchart of an embodiment of a method for initializing a touch screen of the electronic device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, such references mean “at least one.” The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

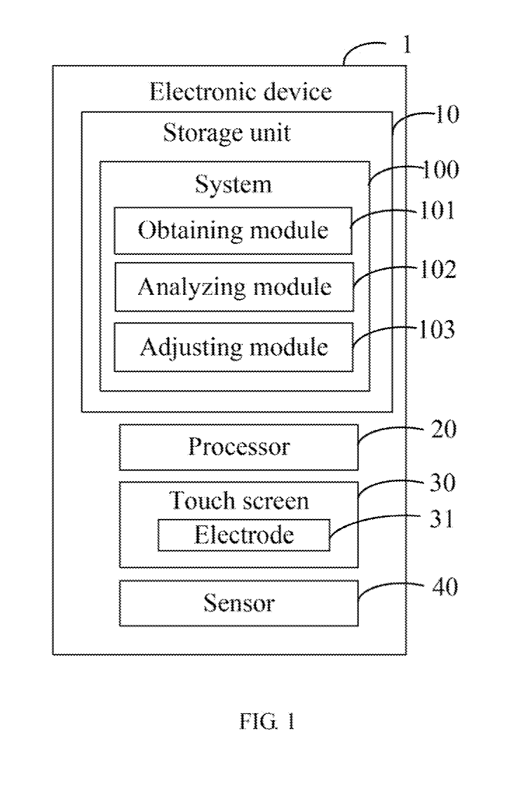

FIG. 1 is a block diagram of an embodiment of an electronic device 1. The electronic device 1, such as a mobile phone, a tablet computer, or a multimedia player, can include a storage unit 10, a processor 20, a touch screen 30, and a sensor 40. The touch screen 30 can include a number of electrodes 31 arranged in rows and columns. The sensor 40 can detect readings of the electronic device 1 or readings of an ambient environment in which the electronic device 1 is located, and such readings may be treated as standard parameters. In an embodiment, the sensor 40 can be a vibration sensor which senses vibration magnitude of the electronic device 1. More specifically, the vibration sensor can be a three-axis gyroscope capable of sensing three dimensional X, Y, and Z axes vibration magnitudes. In an alternative embodiment, the sensor 40 can be an illumination sensor which detects a level of ambient illumination of the environment in which the electronic device 1 is located.

The storage unit 10 can store a system 100 for initializing the touch screen 30. The system 100 can include a variety of modules as a collection of software instructions executable by the processor 20 to provide the functions of the system 100. In an embodiment, the system 100 can be executable by the processor 20 to adjust the electrical potentials of the electrodes to largely at the same level according to the parameters extrapolated from one or more detected readings.

In the example illustrated in FIG. 1, the system 100 can include an obtaining module 101, an analyzing module 102, and an adjusting module 103.

When the touch screen 30 wakes up, the obtaining module 101 periodically obtains readings from the sensor 40, for example, the obtaining module 101 obtains readings from the sensor 40 every two minutes. In detail, when the electronic device 1 has an incoming call or new message, the touch screen 30 wakes up to anticipate the touch screen 30 being operated by the user. Then, the user can shake the electronic device 1 to vary the vibration magnitude of the electronic device 1, or change the level of light to which the electronic device 1 is subjected, by using his hand to vary the ambient illumination of the environment in which the electronic device 1 is located.

The analyzing module 102 determines whether the detected readings vary from parameters previously established. If yes, the analyzing module 102 further compares a variance between the instant detected readings with a preset parameter.

The adjusting module 103 adjusts the electrical potentials of the electrodes 31 to be substantially at the same level if the variance is greater than the preset parameter.

With the above configuration, when the touch screen 30 of the electronic device 1 wakes up, the user can shake the electronic device 1 or place the illumination sensor in shadow, to vary the ambient circumstances of the electronic device 1. Having once detected that the variance between an instant reading and a preset parametric value is greater than a preset value, the electronic device 1 automatically initializes the touch screen 30.

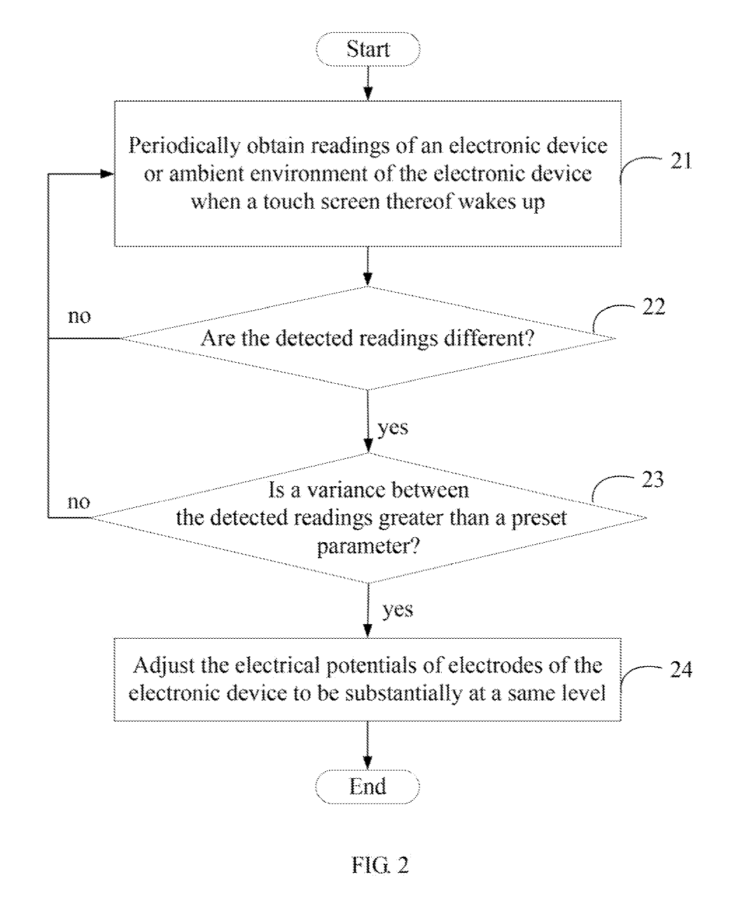

FIG. 2 is a flowchart of an embodiment of a method for initializing a touch screen.

In block 21, an obtaining module periodically obtains readings from a sensor when the touch screen wakes up.

In block 22, an analyzing module determines whether the instant detected readings vary from parameters previously established, if yes, the procedure goes to block 23; otherwise, the block 21 is repeated.

In block 23, the analyzing module compares a variance between the instant detected readings with a preset parameter, and determines whether the variance is greater than the preset parameter, if yes, the procedure goes to block 24; otherwise, block 21 is repeated.

In block 24, an adjusting module adjusts the electrical potentials of electrodes of the touch screen to be substantially at the same level.

It is believed that the present embodiments and their advantages will be understood from the foregoing description, and it will be apparent that various changes may be made thereto without departing from the scope of the disclosure or sacrificing all of its material advantages, the examples hereinbefore described merely being exemplary embodiments of the present disclosure.

What is claimed is:

1. An electronic device comprising:
a touch screen comprising a plurality of electrodes;
a sensor to detect readings of at least one of the electronic device and the electronic device's ambient environment of the electronic device; and
a processor to execute a plurality of modules,
wherein the plurality of modules comprises:
an obtaining module that periodically obtains detected readings from the sensor when the touch screen wakes up;
an analyzing module that determines whether the detected readings are different, and compare a variance between the detected readings with a preset parameter; and
an adjusting module that adjusts electrical potentials of the electrodes to be substantially at a same level if the variance is greater than the preset parameter.

2. The electronic device of claim 1, wherein the sensor is a vibration sensor configured to sense vibration magnitude of the electronic device.

3. The electronic device of claim 2, wherein the vibration sensor is a three-axis gyroscope capable of sensing three dimensional X, Y, and Z axes vibration magnitudes.

4. The electronic device of claim 1, wherein the sensor is an illumination sensor configured to detect a level of ambient illumination of the environment of the electronic device.

5. A method for initializing a touch screen included in an electronic device, the touch screen comprising a plurality of electrodes, the electronic device comprising a sensor to detect readings of at least one of the electronic device and the ambient environment of the electronic device, the method comprising:
periodically obtaining detected readings from the sensor when the touch screen wakes up;
determining whether the detected readings are different;
comparing a variance between the detected readings with a preset parameter; and
adjusting electrical potentials of the electrodes to be substantially at a same level if the variance is greater than the preset parameter.
